(19) United States
(12) Patent Application Publication
(10) Pub. No.: US 2024/0255731 A1
(43) Pub. Date: Aug. 1, 2024

(54) 6P LENS SUITABLE FOR SMALL MOUNTING HOLE

(71) Applicant: Hubei Huaxin Photoelectric Co., Ltd., Yichang (CN)

(72) Inventors: GUISU GUO, Yichang (CN); XIUMEI CHEN, Yichang (CN)

(21) Appl. No.: 18/538,218

(22) Filed: Dec. 13, 2023

(30) Foreign Application Priority Data
Jan. 28, 2023 (CN) 202310098860.2

(51) Int. Cl. G02B 9/62; G02B 13/18

(52) U.S. Cl. CPC G02B 9/62; G02B 13/18

(57) ABSTRACT

A 6P lens suitable for small mounting hole, comprising an aperture stop, a first, second, third, fourth, fifth and sixth lens along the optical axis from the object side to the image side. An object surface of the first lens is convex, and changes from the convex surface to the concave surface, an image surface is concave, changes from the concave surface to the convex surface from the near optical axis to the periphery; An object surface of the second lens is convex and an image surface is concave; An object surface of the third lens is concave, an image surface is convex; An object surface of the fourth lens is concave, an image surface is convex; An object surface of the fifth lens is concave, an image surface is convex; An object surface of the sixth lens is a concave surface, and its image surface is convex.

### CROSS-REFERENCE TO RELATED APPLICATIONS

This application claims priority to Chinese Patent Application No. 202310098860.2, filed on Jan. 28, 2023, which is hereby incorporated by reference in its entirety.

### TECHNICAL FIELD

The present application relates to the field of optical devices, and more specifically, to a 6P lens suitable for small mounting hole.

### BACKGROUND

In response to changes in market demand, today's mobile phones are getting thinner and thinner, and the requirements for camera quality are getting higher and higher, and the front-facing lens is required to occupy as little space as possible on the front panel of the mobile phone. In order to meet the increasingly higher requirements for camera lenses, the design of the camera needs to simplify the structure as much as possible, improve clarity, reduce lens weight, reduce lens distortion, etc. Therefore, it is necessary to provide a high-definition optical lens that can meet the requirements.

### SUMMARY

Based on the needs in the background technology, a 6P lens for small mounting holes is provided, which can reduce the diameter of the lens mounting hole, make the total length of the lens sufficiently short and small in size, and at the same time meet the requirements of high-definition imaging.

The technical solutions of the present application to solve the above technical problems are as follows:

A 6P lens suitable for small mounting hole comprises an aperture stop, a first lens, a second lens, a third lens, a fourth lens, a fifth lens and a sixth lens along an optical axis from an object side to an image side.

The first lens is a positive lens, wherein its object surface is convex at a near optical axis and changes from a convex surface to a concave surface from the near optical axis to the periphery, its image surface is concave at the near optical axis and changes from the concave surface to the convex surface from the near optical axis to the periphery;

The second lens is a negative lens, wherein its object surface is convex and its image surface is concave;

The third lens is a positive lens, wherein its object surface is concave and its image surface is convex;

The fourth lens is a negative lens, wherein its object surface is concave and its image surface is convex;

The fifth lens is a positive lens, wherein its object surface is concave and its image surface is convex, and the fifth lens is generally curved toward the object side;

The sixth lens is a negative lens, wherein its object surface is a concave surface and its image surface is convex, and the larger radial dimensions of both surfaces of the sixth lens are curved toward the object side.

On the basis of the above technical solution, the present application can also make the following improvements.

In an implementation mode of the present application, a focal length F1 of the first lens and a total focal length EFL of the lens satisfy a following condition:

$$\\ 0.75 < F 1 / EFL < 0.98 .$$

In an implementation mode of the present application, a combined focal length F123 of the first lens, the second lens and the total focal length EFL of the lens satisfy a following condition:

$$\\ 5 < F 123 / EFL < 9.$$

In an implementation mode of the present application, a focal length F5 of the fifth lens and the total focal length EFL of the lens satisfy a following condition:

$$\\ 0.7 < F 5 / EFL < 0.85 .$$

In an implementation mode of the present application, the total focal length EFL of the lens and a total optical length TTL of the lens meet a following condition:

$$\\ 0.82 < EFL / TTL < 0.88 .$$

The total optical length TTL of the lens is a distance from the first lens to an image surface.

The present application provides a 6P lens for small mounting holes. While meeting the needs of high-definition imaging and larger chip size, the lens is small in size and occupies a small space on the mobile phone panel. At the same time, the total length of the lens is short and meets the requirement of ultra-thin mobile phones. The focal length of the first lens is F1, 0.75<F1/EFL<0.98, which is beneficial to increase the amount of light, control the outer diameter of the second lens, and reduce the overall size of the lens. 5<F123/EFL<9, which is helpful for correcting lens distortion. The focal length of the fifth lens is F5, 0.7<F5/EFL<0.85, which is beneficial to correcting off-axis aberrations and compensating for chromatic aberration. It also improves the capabilities of the sixth lens, improving the performance of the lens and the stability of environmental testing.

### BRIEF DESCRIPTION OF DRAWINGS

FIG. 1 is a schematic structural diagram of a 6P lens suitable for small mounting hole according to the first embodiment of the present application;

FIG. 2 is a relative illumination diagram of a 6P lens suitable for small mounting hole according to the first embodiment;

FIG. 3 is a schematic diagram of field curvature and distortion of a 6P lens suitable for small mounting hole according to the first embodiment;

FIG. 4 is a Ray fan diagram of a 6P lens suitable for small mounting hole according to the first embodiment;

FIG. 5 is a MTF curve chart of a 6P lens suitable for small mounting hole according to the first embodiment at different frequencies;

FIG. 6 is a schematic structural diagram of a 6P lens suitable for small mounting hole according to the second embodiment of the present application;

FIG. 7 is a relative illumination diagram of a 6P lens suitable for small mounting hole according to the second embodiment;

FIG. 8 is a schematic diagram of field curvature and distortion of a 6P lens suitable for small mounting hole according to the second embodiment;

FIG. 9 is a Ray fan diagram of a 6P lens suitable for small mounting hole according to the second embodiment;

FIG. 10 is a MTF curve chart of a 6P lens suitable for small mounting hole according to the second embodiment at different frequencies;

FIG. 11 is a schematic structural diagram of a 6P lens suitable for small mounting hole according to the third embodiment of the present application;

FIG. 12 is a relative illumination diagram of a 6P lens suitable for small mounting hole according to the third embodiment;

FIG. 13 is a field curvature distortion diagram of a 6P lens suitable for small mounting hole according to the third embodiment;

FIG. 14 is a Ray fan diagram of the lens of a 6P lens suitable for small mounting hole according to the third embodiment;

FIG. 15 is a MTF curve chart at different frequencies of a 6P lens suitable for small mounting hole according to the third embodiment.

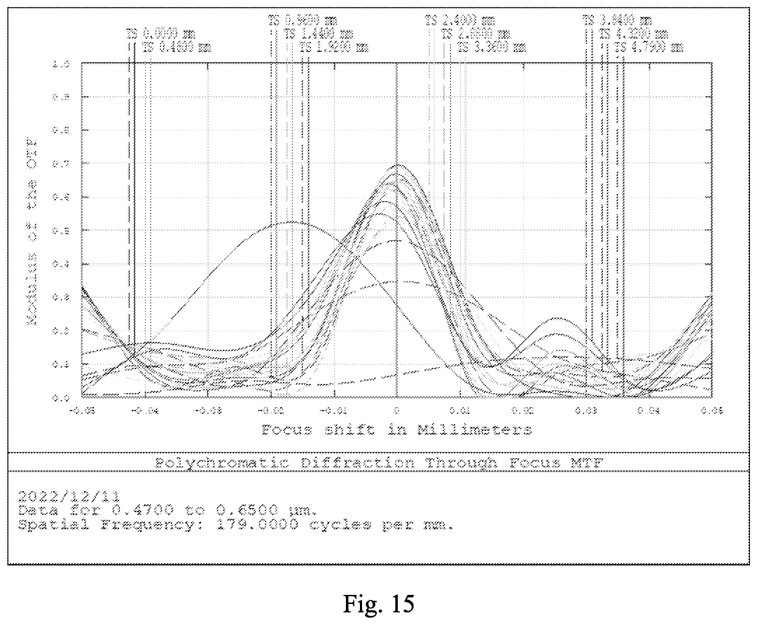

In the Figures, the parts represented by each number are listed as follows:
L1, First lens, L2, Second lens, L3, Third lens, L4, Fourth lens, L5, Fifth lens, L6, Sixth lens.

### DESCRIPTION OF EMBODIMENTS

In order to make the purpose, technical solutions and advantages of the embodiments of the present application clearer, the technical solutions in the embodiments of the present application will be clearly and completely described below in conjunction with the drawings in the embodiments of the present application. Obviously, the described embodiments are some, but not all, of the embodiments of the present application. Based on the embodiments of the present application, all other embodiments obtained by those of ordinary skill in the art without creative efforts fall within the scope of protection of the present application. In addition, the technical features of various embodiments or single embodiments provided by the present application can be arbitrarily combined with each other to form a feasible technical solution. This combination is not restricted by the sequence of steps and/or structural composition mode, but must be in the form of It is based on what a person of ordinary skill in the art can realize. When the combination of technical solutions appears to be contradictory or cannot be realized, it should be considered that such combination of technical solutions does not exist and is not within the protection scope required by the present application.

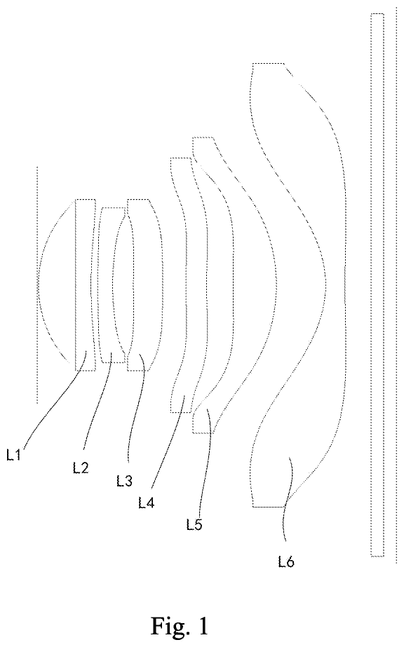

FIG. 1 shows a 6P lens suitable for small mounting hole, it comprises an aperture stop, a first lens, a second lens, a third lens, a fourth lens, a fifth lens and a sixth lens along an optical axis from an object side to an image side.

The first lens L1 is a positive lens, wherein its object surface is convex at a near optical axis and changes from a convex surface to a concave surface from the near optical axis to the periphery, its image surface is concave at the near optical axis and changes from the concave surface to the convex surface from the near optical axis to the periphery.

The second lens L2 is a negative lens, wherein its object surface is convex and its image surface is concave.

The third lens L3 is a positive lens, wherein its object surface is concave and its image surface is convex.

The fourth lens L4 is a negative lens, wherein its object surface is concave and its image surface is convex.

The fifth lens L5 is a positive lens, wherein its object surface is concave and its image surface is convex, and the fifth lens L5 is generally curved toward the object side.

The sixth lens L6 is a negative lens, wherein its object surface is a concave surface and its image surface is convex, and the larger radial dimensions of both surfaces of the sixth lens L6 are curved toward the object side.

It can be understood that the 6P lens suitable for small mounting hole provided by the present application uses the aperture stop, the first lens L1, the second lens L2, The third lens L3, the fourth lens L4, the fifth lens L5 and the sixth lens L6.

The aperture stop limits the imaging beam in the optical system of this lens.

The first lens L1 is a positive lens, wherein its object surface is convex at a near optical axis and changes from a convex surface to a concave surface from the near optical axis to the periphery, its image surface is concave at the near optical axis and changes from the concave surface to the convex surface from the near optical axis to the periphery. The object surface of the first lens L1 is convex, which is beneficial to achieving large relative illumination. Since the object surface of the first lens L1 is convex, the light beam converges after entering, which is beneficial to controlling the outer diameter of the image surface of the second lens L2.

The second lens L2 is a negative lens, wherein its object surface is convex and its image surface is concave. The second lens L2 is close to the first lens L1, which is also beneficial to controlling the outer diameter of the object surface of the second lens L2. The image surface of the second lens L2 is concave. After the light beam exits, the angle is expanded to provide sufficient image height on the rear group and chip, to meet the requirements of the size of the chip and the CRA (Chief Ray Angle).

The third lens L3 is a positive lens, wherein its object surface is concave and its image surface is convex.

The fourth lens L4 is a negative lens, wherein its object surface is concave and its image surface is convex.

The fifth lens L5 is a positive lens, wherein its object surface is concave and its image surface is convex, and the fifth lens L5 is generally curved toward the object side, to avoid excessive light incident angles at larger apertures.

The sixth lens L6 is a negative lens, wherein its object surface is a concave surface and its image surface is convex, and the larger radial dimensions (i.e. the larger aperture of the lens) of both surfaces of the sixth lens L6 are curved toward the object side, to avoid excessive light incident angles at larger apertures.

The focal lengths of the first lens L1, the second lens L2, the third lens L3 and the fifth lens L5 are F1, F2, F3 and F5 respectively. The combined focal length of the first lens L1, the second lens L2 and the third lens L3 is F123, the total focal length of the lens is EFL, and the total optical length of the lens is TTL. The total optical length of the lens TTL represents the distance from the first lens L1 to the image surface.

The focal length F1 of the first lens L1 and a total focal length EFL of the lens satisfy a following condition:

$$\\ 0.75 < F 1 / EFL < 0.98 .$$

The combined focal length F123 of the first lens L1, the second lens L2 and the total focal length EFL of the lens satisfy a following condition:

$$\\ 5 < F 123 / EFL < 9.$$

The focal length F5 of the fifth lens L5 and the total focal length EFL of the lens satisfy a following condition:

$$\\ 0.7 < F 5 / EFL < 0.85 .$$

The total focal length EFL of the lens and a total optical length TTL of the lens meet a following condition:

$$\\ 0.82 < EFL / TTL < 0.88 ,$$

wherein, the total optical length TTL of the lens is a distance from the first lens to an image surface.

Wherein, the lens data of the scanner gun lens according the first embodiment is as follows in Table 1.

TABLE 1

| Surface | | | | | Material | | |
|---|---|---|---|---|---|---|---|
| serial | | Surface | Radius of | | | Refractive | Abbe |
| number | Element | type | curvature | Thickness | Type | index | number |
| 0 | Object | Flat | infinite | infinite | | | |
| | surface | | | | | | |
| 1 | Aperture | Flat | | −0.647031 | | | |
| 2 | First lens | Aspherical | 2.000797 | 0.909330 | Plastic | 1.544502 | 55.9870 |
| 3 | | Aspherical | 6.252158 | 0.117467 | | | |
| 4 | Second lens | Aspherical | 9.571141 | 0.260018 | Plastic | 1.671339 | 19.2429 |
| 5 | | Aspherical | 4.555192 | 0.358146 | | | |
| 6 | Third lens | Aspherical | 22.356987 | 0.504208 | Plastic | 1.544502 | 55.9870 |
| 7 | | Aspherical | −177.282127 | 0.403105 | | | |
| 8 | Fourth lens | Aspherical | 7.574806 | 0.357948 | Plastic | 1.661417 | 20.4122 |
| 9 | | Aspherical | 5.984649 | 0.458347 | | | |
| 10 | Fifth lens | Aspherical | 12.267318 | 0.748749 | Plastic | 1.544502 | 55.9870 |
| 11 | | Aspherical | −2.901008 | 0.853255 | | | |
| 12 | Sixth lens | Aspherical | −1.812508 | 0.334775 | Plastic | 1.535037 | 55.7107 |
| 13 | | Aspherical | 20.226772 | 0.455781 | | | |
| 14 | Filter | Flat | | 0.21 | Glass | 1.516800 | 64.1673 |
| 16 | Image | Flat | | 0 | | | |
| | surface | | | | | | |

The conditions satisfied by the optical parameters of each lens meet are shown in Table 2:

TABLE 2

| | |
|---|---|
| F1/EFL= | 0.9526 |
| F123/EFL= | 5.3798 |
| F5/EFL= | 0.8315 |
| EFL/TTL= | 0.8483 |

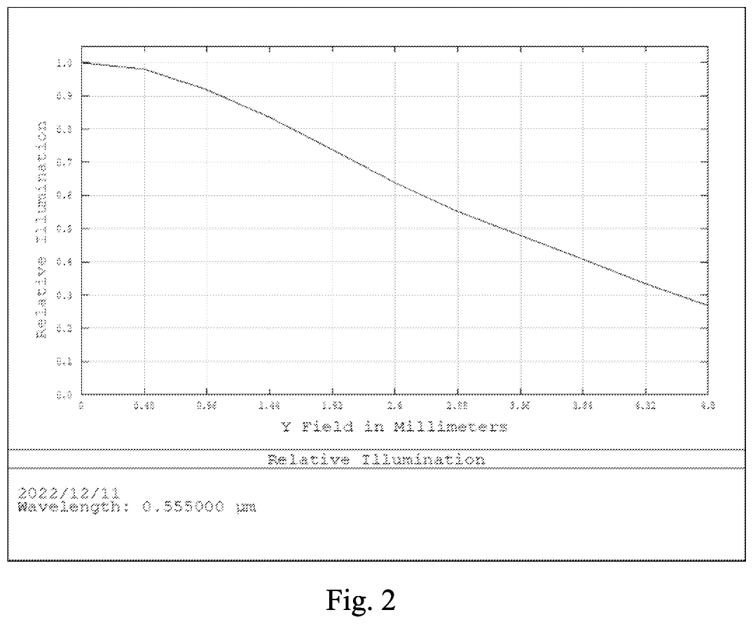

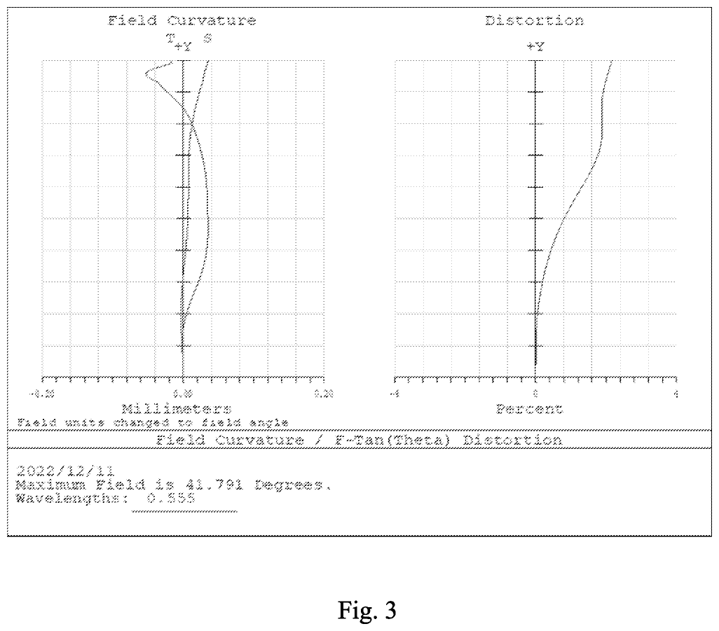

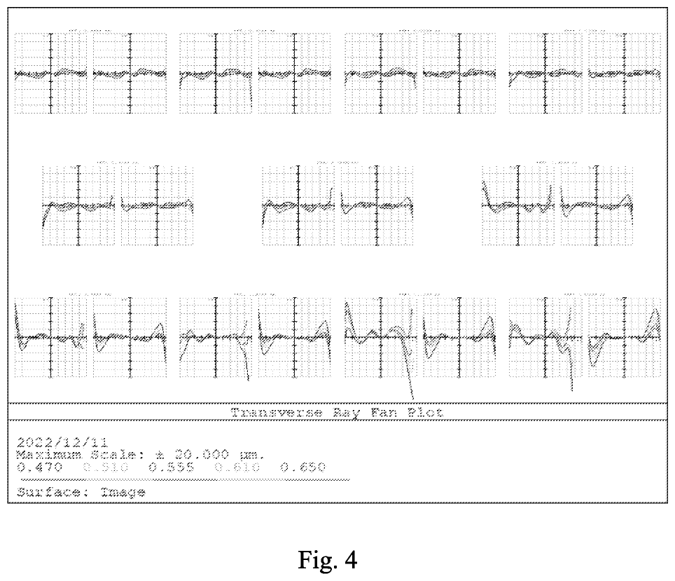

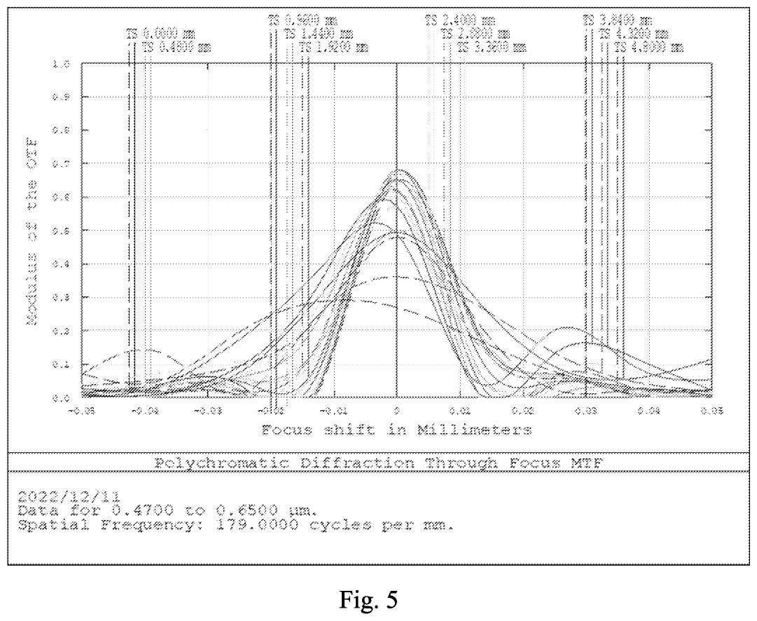

FIG. 2 is a relative illumination diagram of the lens according to the first embodiment. The higher the value, the better the relative illumination. FIG. 3 is a schematic diagram of field curvature and distortion of the lens according to the first embodiment. The left side is field curvature and the right side is distortion. The closer to the center, the better the imaging effect. FIG. 4 is a Ray fan diagram of the lens according to the first embodiment The smaller the value, the better the imaging effect. FIG. 5 is a MTF curve chart of the lens according to the first embodiment at different frequencies. The smoother the curve and the higher the value, the better the imaging effect of the lens.

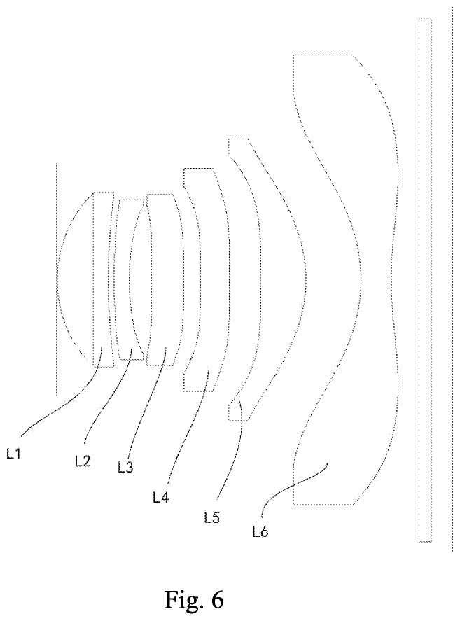

FIG. 6 is a schematic structural diagram of the lens suitable for small mounting hole according the second embodiment. The structure is the same as that of the first embodiment. The difference is that the lens data and optical parameters meet different conditions.

The lens data of each lens according to the second embodiment is as shown in Table 3.

TABLE 3

| Surface | | | | | Material | | |
|---|---|---|---|---|---|---|---|
| serial | | Surface | Radius of | | | Refractive | Abbe |
| number | Element | type | curvature | Thickness | Type | index | number |
| 0 | Object | Flat | infinite | infinite | | | |
| | surface | | | | | | |
| 1 | Aperture | Flat | | −0.634821 | | | |
| 2 | First lens | Aspherical | 2.224157 | 0.904551 | Plastic | 1.544502 | 55.9870 |
| 3 | | Aspherical | 8.067336 | 0.099352 | | | |
| 4 | Second lens | Aspherical | 6.688001 | 0.271117 | Plastic | 1.661417 | 20.4122 |
| 5 | | Aspherical | 3.916996 | 0.392819 | | | |
| 6 | Third lens | Aspherical | 71.910940 | 0.569321 | Plastic | 1.535037 | 55.7107 |
| 7 | | Aspherical | −60.470875 | 0.296288 | | | |
| 8 | Fourth lens | Aspherical | 48.885407 | 0.508339 | Plastic | 1.661417 | 20.4122 |
| 9 | | Aspherical | 20.700579 | 0.558117 | | | |
| 10 | Fifth lens | Aspherical | −45.73536 | 0.798527 | Plastic | 1.535037 | 55.7107 |
| 11 | | Aspherical | −2.458453 | 0.970759 | | | |
| 12 | Sixth lens | Aspherical | −2.924481 | 0.535286 | Plastic | 1.535037 | 55.7107 |
| 13 | | Aspherical | 5.257839 | 0.5 | | | |
| 14 | Filter | Flat | | 0.21 | Glass | 1.516800 | 64.1673 |
| 16 | Image | Flat | | 0 | | | |
| | surface | | | | | | |

Wherein, the conditions satisfied by the optical parameters of each lens are as follows Table 4 below.

TABLE 4

| | |
|---|---|
| F1/EFL= | 0.8965 |
| F123/EFL= | 8.8595 |
| F5/EFL= | 0.8228 |
| EFL/TTL= | 0.8363 |

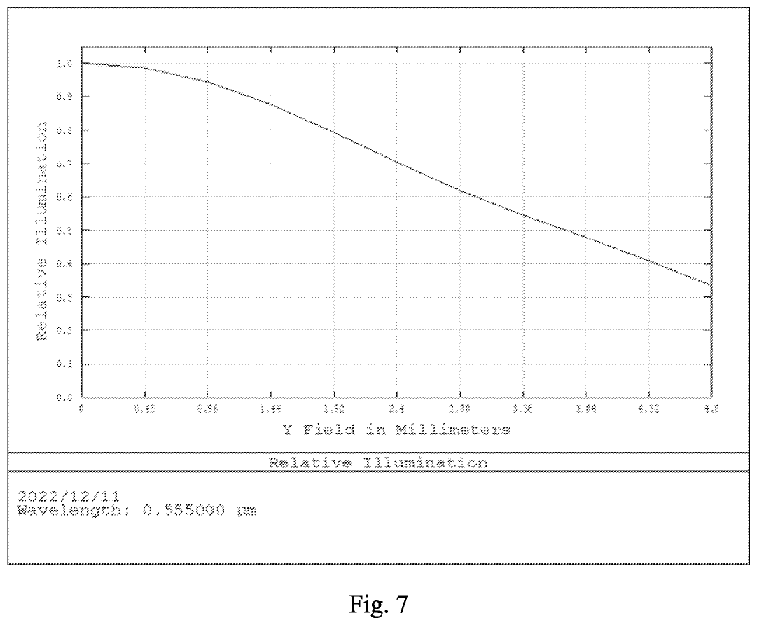

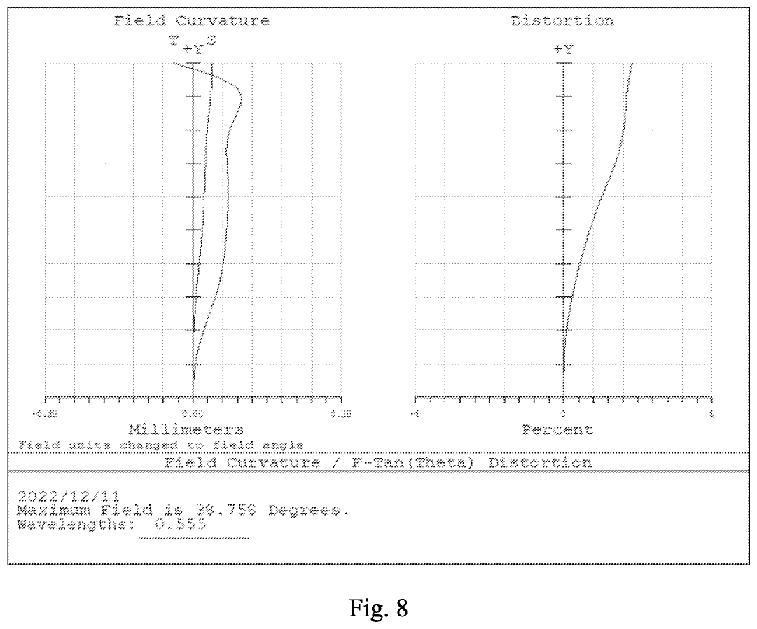

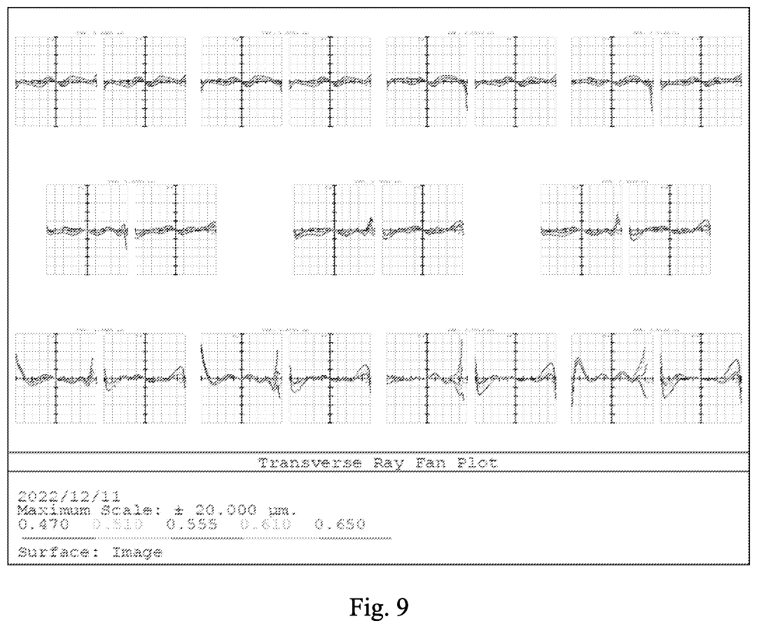

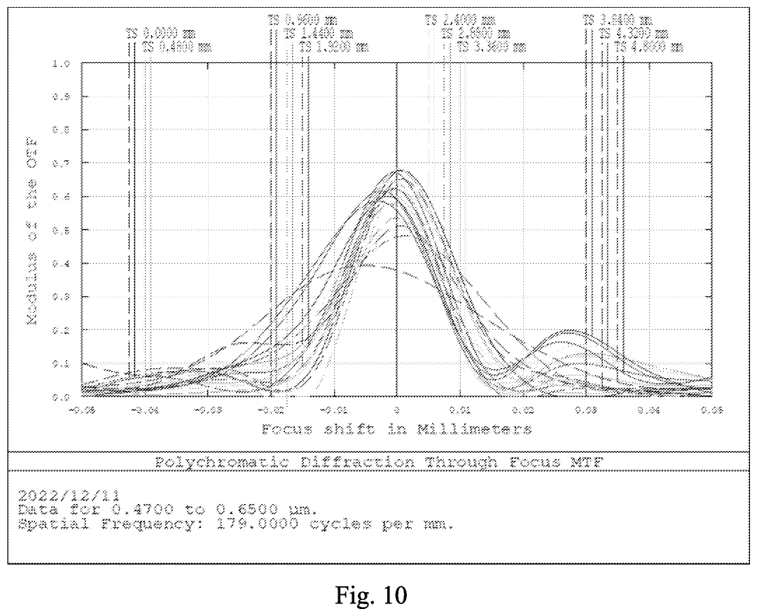

Similarly, FIG. 7 is a relative illumination diagram of the lens according to the second embodiment. The higher the value, the better the relative illumination. FIG. 8 is a schematic diagram of field curvature and distortion of the lens according to the second embodiment. The left side is field curvature and the right side is distortion. The closer to the center, the better the imaging effect. FIG. 9 is a Ray fan diagram of the lens according to the second embodiment. The smaller the value, the better the imaging effect. FIG. 10 is a MTF curve chart of the lens according to the first embodiment at different frequencies. The smoother the curve and the higher the value, the better the imaging effect of the lens.

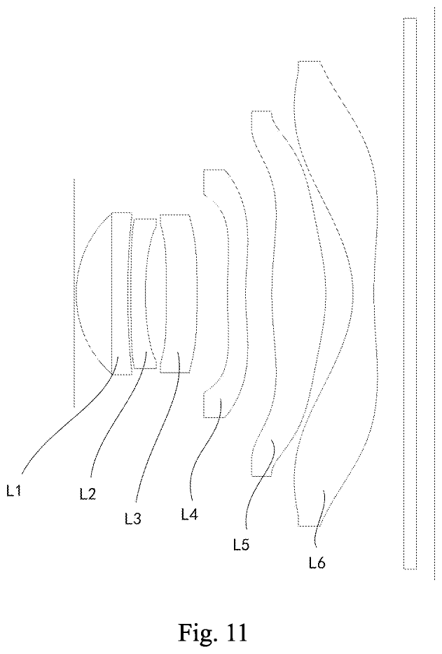

FIG. 11 is a schematic structural diagram of the 6P lens suitable for small mounting hole according to the third embodiment. The structure is the same as that of the first embodiment and the second embodiment. The difference is that the lens data and optical parameters meet different conditions.

The lens data of each lens according to the third embodiment is as shown in Table 5.

TABLE 5

| Surface | | | | | Material | | |
|---|---|---|---|---|---|---|---|
| serial | | Surface | Radius of | | | Refractive | Abbe |
| number | Element | type | curvature | Thickness | Type | index | number |
| 0 | Object | Flat | infinite | infinite | | | |
| | surface | | | | | | |
| 1 | Aperture | Flat | | −0.594992 | | | |
| 2 | First lens | Aspherical | 1.860566 | 0.861651 | Plastic | 1.544502 | 55.9870 |
| 3 | | Aspherical | 10.444067 | 0.052694 | | | |
| 4 | Second lens | Aspherical | 21.823262 | 0.241635 | Plastic | 1.661417 | 20.4122 |
| 5 | | Aspherical | 4.949804 | 0.351491 | | | |
| 6 | Third lens | Aspherical | −54.079199 | 0.512654 | Plastic | 1.635517 | 23.9718 |
| 7 | | Aspherical | −21.6546 | 0.503278 | | | |
| 8 | Fourth lens | Aspherical | 6.125907 | 0.304584 | Plastic | 1.639730 | 23.5289 |
| 9 | | Aspherical | 4.465884 | 0.439178 | | | |
| 10 | Fifth lens | Aspherical | 5.877145 | 0.901271 | Plastic | 1.544502 | 55.9870 |
| 11 | | Aspherical | −2.979409 | 0.455827 | | | |
| 12 | Sixth lens | Aspherical | −1.887136 | 0.347207 | Plastic | 1.535037 | 55.7107 |
| 13 | | Aspherical | 6.711351 | 0.5 | | | |
| 14 | Filter | Flat | | 0.21 | Glass | 1.516800 | 64.1673 |
| 16 | Image | Flat | | 0 | | | |
| | surface | | | | | | |

The conditions satisfied by the optical parameters of the lenses are as follows Table 6 below.

TABLE 6

| | |
|---|---|
| F1/EFL= | 0.7771 |
| F123/EFL= | 5.1500 |
| F5/EFL= | 0.7289 |
| EFL/TTL= | 0.8592 |

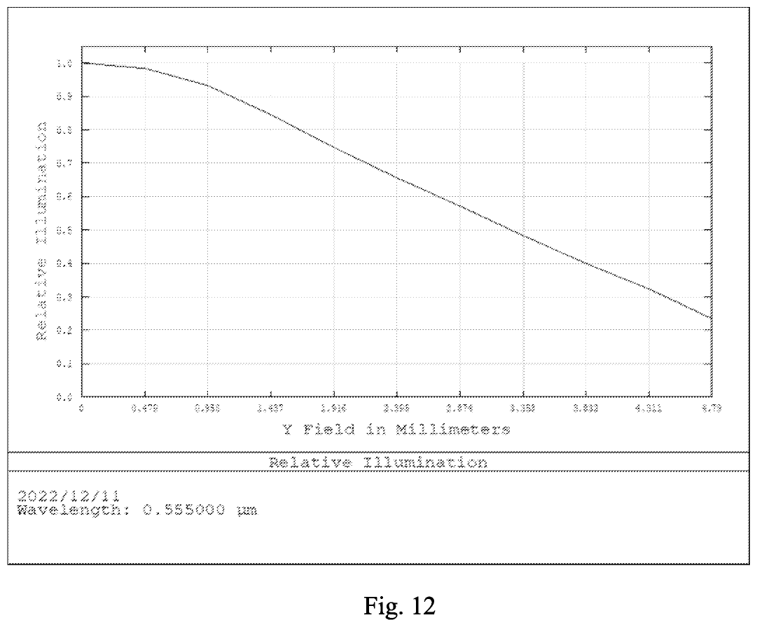

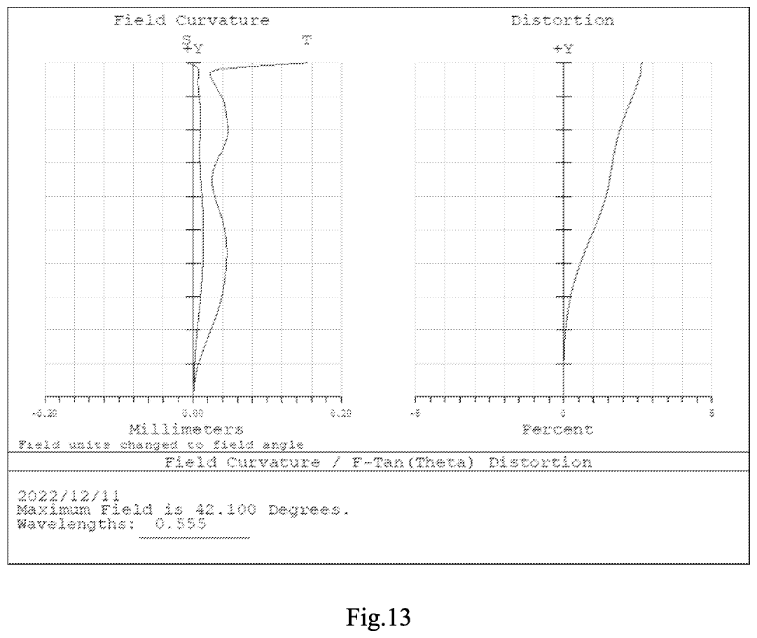

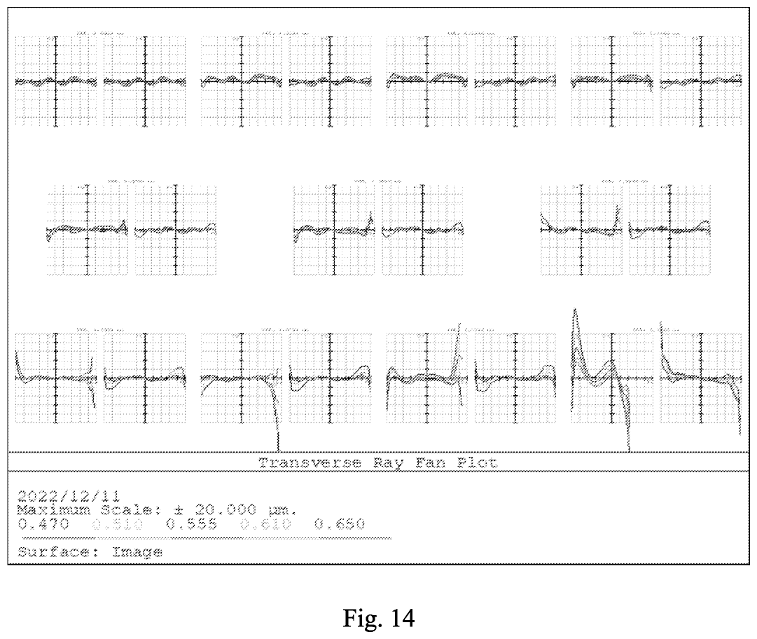

Similar, FIG. 12 is a relative illumination diagram of the lens according to the third embodiment. The higher the value, the better the relative illumination. FIG. 13 is a schematic diagram of field curvature and distortion of the lens according to the third embodiment. The left side is field curvature and the right side is distortion. The closer to the center, the better the imaging effect. FIG. 14 is a Ray fan diagram of the lens according to the third embodiment The smaller the value, the better the imaging effect. FIG. 5 is a MTF curve chart of the lens according to the third embodiment at different frequencies. The smoother the curve and the higher the value, the better the imaging effect of the lens.

The present application provides a 6P lens for small mounting holes. While meeting the needs of high-definition imaging and larger chip size, the lens is small in size and occupies a small space on the mobile phone panel. At the same time, the total length of the lens is short and meets the requirement of ultra-thin mobile phones. The focal length of the first lens is F1, 0.75<F1/EFL<0.98, which is beneficial to increase the amount of light, control the outer diameter of the second lens, and reduce the overall size of the lens. 5<F123/EFL<9, which is helpful for correcting lens distortion. The focal length of the fifth lens is F5, 0.7<F5/EFL<0.85, which is beneficial to correcting off-axis aberrations and compensating for chromatic aberration. It also improves the capabilities of the sixth lens, improving the performance of the lens and the stability of environmental testing.

It should be noted that in the above embodiments, each embodiment has its own emphasis in description. For parts that are not described in detail in a certain embodiment, please refer to the relevant descriptions of other embodiments.

Although the preferred embodiments of the present application have been described, those skilled in the art will be able to make additional changes and modifications to these embodiments once the basic inventive concept is understood. Therefore, it is intended that the appended claims be construed to include the preferred embodiments and all changes and modifications that fall within the scope of the invention.

Obviously, those skilled in the art can make various changes and modifications to the present application without departing from the spirit and scope of the invention. In this way, if these modifications and variations of the present application fall within the scope of the claims of the present application and equivalent technologies, the present application is also intended to include these modifications and variations.

What is claimed is:

1. A 6P lens suitable for small mounting hole, comprising an aperture stop, a first lens, a second lens, a third lens, a fourth lens, a fifth lens and a sixth lens along an optical axis from an object side to an image side;
the first lens is a positive lens, wherein its object surface is convex at a near optical axis and changes from a convex surface to a concave surface from the near optical axis to the periphery, its image surface is concave at the near optical axis and changes from the concave surface to the convex surface from the near optical axis to the periphery;
the second lens is a negative lens, wherein its object surface is convex and its image surface is concave;
the third lens is a positive lens, wherein its object surface is concave and its image surface is convex;
the fourth lens is a negative lens, wherein its object surface is concave and its image surface is convex;
the fifth lens is a positive lens, wherein its object surface is concave and its image surface is convex, and the fifth lens is generally curved toward the object side;
the sixth lens is a negative lens, wherein its object surface is a concave surface and its image surface is convex, and the larger radial dimensions of both surfaces of the sixth lens are curved toward the object side.

2. The 6P lens suitable for small mounting hole according to claim 1, wherein a focal length F1 of the first lens and a total focal length EFL of the lens satisfy a following condition:
$$\\ 0.75 < F 1 / EFL < 0.98 .$$

3. The 6P lens suitable for small mounting hole according to claim 1, wherein a combined focal length F123 of the first lens, the second lens and the total focal length EFL of the lens satisfy a following condition:
$$\\ 5 < F 123 / EFL < 9.$$

4. The 6P lens suitable for small mounting hole according to claim 1, wherein a focal length F5 of the fifth lens and the total focal length EFL of the lens satisfy a following condition:
$$\\ 0.7 < F 5 / EFL < 0.85 .$$

5. The 6P lens suitable for small mounting hole according to claim 1, wherein the total focal length EFL of the lens and a total optical length TTL of the lens meet a following condition:
$$\\ 0.82 < EFL / TTL < 0.88 ,$$
wherein, the total optical length TTL of the lens is a distance from the first lens to an image surface.
